(19) United States
(12) Patent Application Publication
(10) Pub. No.: US 2020/0364926 A1
(43) Pub. Date: Nov. 19, 2020

(54) METHODS AND APPARATUS FOR ADAPTIVE OBJECT SPACE SHADING

(71) Applicant: QUALCOMM Incorporated, San Diego, CA (US)

(72) Inventors: Joerg Hermann MUELLER, Graz (AT); Thomas NEFF, Graz (AT); Dieter SCHMALSTIEG, Graz (AT)

(21) Appl. No.: 16/414,674

(22) Filed: May 16, 2019

(51) Int. Cl. G06T 15/80; G06T 15/50; G06T 7/20

(52) U.S. Cl. CPC G06T 15/80; G06T 2200/04; G06T 7/20; G06T 15/503

(57) ABSTRACT

The present disclosure relates to methods and devices for operation of a graphics processing unit (GPU). The device can determine a first shading value for each primitive in a first set of primitives associated with objects in a first frame. The device can also determine a second shading value for each primitive in a second set of primitives associated with objects in a second frame. Additionally, the device can calculate a shading difference for each primitive in both the first set of primitives and the second set of primitives. In some aspects, the shading difference is the difference between the first shading value and the second shading value for the primitive. Moreover, the device can shade each primitive in response to determining the shading difference is greater than a threshold, where each shaded primitive is in a third set of primitives.

### TECHNICAL FIELD

The present disclosure relates generally to processing systems and, more particularly, to one or more techniques for graphics processing in processing systems.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the advent of wireless communication and smaller, handheld devices, there has developed an increased need for improved graphics processing.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a first apparatus are provided. The apparatus may be a GPU. In some aspects, the apparatus may be configured to determine a first shading value for each primitive in a first set of primitives associated with objects in a first frame. The apparatus can also be configured to determine a second shading value for each primitive in a second set of primitives associated with objects in a second frame. Additionally, the apparatus can be configured to calculate a shading difference for each primitive in both the first set of primitives and the second set of primitives. In some aspects, the shading difference is the difference between the first shading value and the second shading value for the primitive. Moreover, the apparatus can be configured to shade each primitive in response to determining the shading difference is greater than a threshold, where each shaded primitive is in a third set of primitives.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation and coding system in accordance with the techniques of this disclosure.

FIGS. 2A and 2B illustrate example images according to the present disclosure.

FIGS. 3A-3C illustrate other example images according to the present disclosure.

FIG. 4 illustrates an example flowchart of an example method in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

As used herein, instances of the term “content” may refer to graphical content or display content. In some examples, as used herein, the term “graphical content” may refer to a content generated by a processing unit configured to perform graphics processing. For example, the term “graphical content” may refer to content generated by one or more processes of a graphics processing pipeline. In some examples, as used herein, the term “graphical content” may refer to content generated by a graphics processing unit. In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

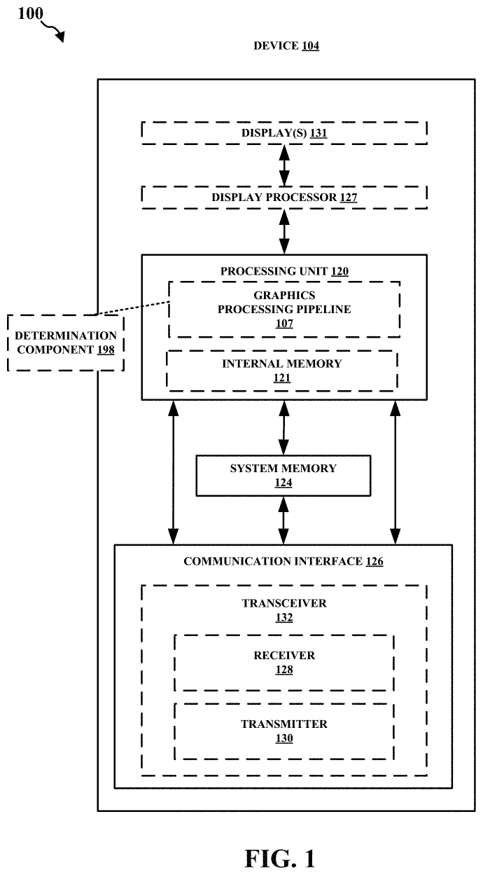

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 may be communicatively coupled to each other over the bus or a different connection.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the graphics processing pipeline 107 may include a determination component 198 configured to determine a first shading value for each primitive in a first set of primitives associated with objects in a first frame. The determination component 198 can also be configured to determine a second shading value for each primitive in a second set of primitives associated with objects in a second frame. Additionally, the determination component 198 can be configured to calculate a shading difference for each primitive in both the first set of primitives and the second set of primitives. In some aspects, the shading difference can be the difference between the first shading value and the second shading value for the primitive. The determination component 198 can also be configured to shade each primitive in response to determining the shading difference is greater than a threshold, where each shaded primitive is in a third set of primitives.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein

In applications including computer graphics, there are many techniques and operations that are based on the visibility of images. For instance, this visibility can be based on a construct of geometric primitives. These geometric primitives can take on a variety of shapes, e.g., triangles. In some aspects, the visibility information pertaining to these geometric primitives can be based on a specific operation, e.g., a computer algorithm. Some aspects of computer graphics, e.g., virtual reality (VR), can utilize pixel or object shading, i.e., object space shading or decoupled shading, where reliable visibility information is important. With the increase in high frames rates to satisfy or smooth the VR experience, there is an increased need for a high number or density of shaded pixels within VR images. Combined with low latency requirements and larger field of view requirements, this desire for an increased pixel density can prove problematic for graphics cards.

In certain aspects of rendering a scene or image, primitive or triangle data can be rendered through the process of rasterization, which is sending a primitive or triangle data stream to a GPU to then generate the scene. Rendered primitives or triangles can then be sampled by the GPU following a raster. In some aspects of pixel or object shading, the shading information can be sampled based on the locations of geometric primitives. Sampling this visibility information from a scene or video can present a variety of potential difficulties, such as accounting for camera movement. For instance, shading or sampling primitives can become problematic when the visibility and the display does not use the same viewing parameters, i.e., if the camera parameters or resolution are not the same. For certain scenarios, e.g., VR, small viewpoint offsets between the visibility and display can reduce the display latency. Accordingly, it can be desirable to support camera adjustments between these stages.

Object space shading stores shading results in an object space instead of in a final image space. The object space is often the texture space of the models, such as in texel shading. In some aspects, this can be a way to reduce graphical content in a video, VR, or video game. Games engines can also utilize a deferred rendering framework, which can have a two-step rendering process. In shading atlas streaming, the object space can be the atlas, where patches of the models are shaded within rectangular blocks. In some aspects, this can be a compressed representation of an atlas.

In some aspects of the present disclosure, rendering applications can exhibit temporal coherence, i.e., where surface points remain visible between successive frames. For instance, some real-time rendering applications can exhibit a higher percentage of temporal coherence, e.g., more than 90% temporal coherence. In some aspects, the present disclosure may not need to re-compute the pixel shading based on the temporal coherence. In some instances, with standard forward rendering or image based rendering, it can be difficult to take advantage of temporal coherence. Further, some methods can rely on image-space caching. Object space shading can allow for straightforward exploitation of temporal coherence, e.g., due to the explicit mapping into an object space. Accordingly, some aspects of object space shading may allow a server to save storage, time, and/or money.

As mentioned above, real-time rendering applications may exhibit greater than 90% temporal coherence, i.e., surface points remaining visible between successive frames. In some aspects, it may be difficult to take advantage of temporal coherence with standard forward rendering or image based rendering. Thus, some methods of rendering may rely on image-space caching. The present disclosure can utilize object space shading, e.g., storing shading results in object space rather than in the final image space. This can allow for straightforward exploitation of temporal coherence via explicit mapping into object space. Additionally, a shading difference can be computed for each shaded primitive between a current frame and a previously shaded frame. A small shading difference may indicate that the primitive is unlikely to be needed in the near future, and is instead scheduled for shading in a certain number of frames, e.g., N frames, which can be weighted by the shading difference. A large shading difference may indicate that shading for a particular primitive is currently changing, and the primitive can be scheduled for shading sooner. In addition, a small amount of shading can be view-dependent, which can increase performance and offset the cost of computing the shading differences.

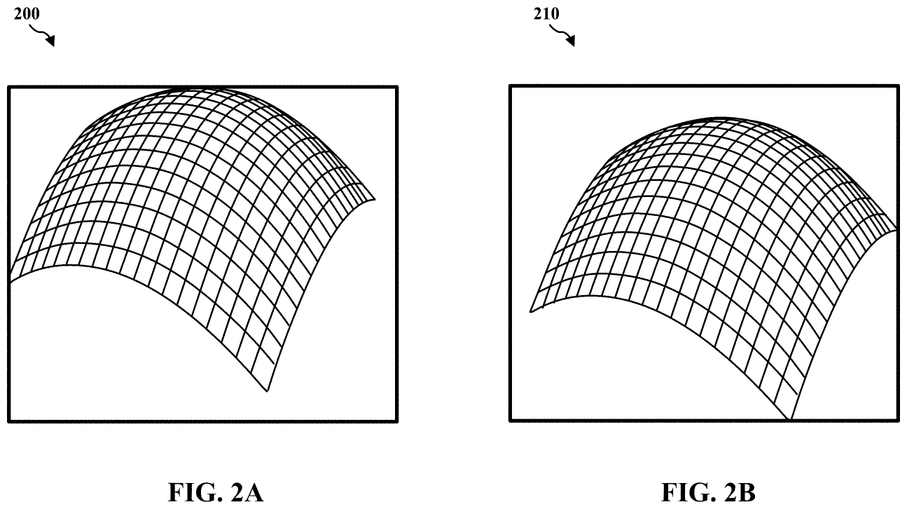

FIGS. 2A and 2B illustrate images 200 and 210, respectively, according to the present disclosure. More specifically, images 200 and 210 are successive frames. FIGS. 2A and 2B show that there may not be much of a difference between successive frames, as the images 200 and 210 are similar to one another. For instance, the shading in successive frames may not change much if the camera angle is only changed slightly. Moreover, if the difference in visible geometry between successive frames is small, then the shading results for the successive frames may be reused. This can provide a number of benefits, such as performance and/or cost savings.

In some aspects, the present disclosure can compute shading differences for each shaded primitive or patch of primitives between successive frames, e.g., the current frame and the previously shaded frame. In these aspects, the present disclosure can calculate the difference between successive frames. For example, if the shading difference between frames is relatively small, the present disclosure may assume that re-shading is unlikely to be needed in the near future. Accordingly, the present disclosure can schedule shading a certain number of frames in the future, e.g., N frames. The delay until shading is performed in the future can also be inversely proportional to the shading difference. As such, if the shading difference is small, then the present disclosure can assume that re-shading is not necessary. Indeed, for every frame and primitive, the present disclosure can either re-compute or re-shade, or leave the shading the same as the previous frame. So the present disclosure can either update the primitives in a certain frame, or wait to update the primitives in another frame. In some aspects, if the shading difference for a primitive in successive frames is large, the present disclosure can assume that shading this particular primitive is a high priority. Thus, the present disclosure can schedule the primitive for shading earlier than other primitives with lower shading priority.

In some aspects, a primitive may receive a shading deadline by which the primitive may be shaded. In these aspects, the primitives may be inserted into a shading queue and sorted according to their respective shading deadline. In some instances, the de-queueing of the shading queue can be deterministic, such that the primitives with a shading deadline for the current frame may be removed from the shading queue. Accordingly, in some aspects, the shading queue can be an implementation tool to implement the shading deadlines of the primitives. For example, if a primitive is slowly changing from light to dark in successive frames, it can be updated in the shading queue. In some aspects, with each successive frame, the primitive's re-shading priority can be adjusted in the shading queue.

If the primitive shading is dependent on a particular camera view, it can be referred to as view dependent shading. Likewise, if the primitive is not dependent on a particular camera view, then it can be referred to as view independent shading. If only a small amount of shading in a frame is view dependent, this can increase performance and offset any additional cost of computing the shading differences. In some aspects of shading, each primitive or patch of primitives may only be re-shaded when necessary. In other aspects of shading, every primitive or patch of primitives may be re-shaded with every frame. In further aspects, the shading may be based on the view dependent status. For example, view dependent shading may re-shade primitives with every frame. In contrast, view independent shading may only re-shade when needed.

In some aspects, the present disclosure can update the primitive shading based on the rate of change of the primitives' shading. In these aspects, to determine whether the present disclosure should re-shade the primitives, the rate of change or frequency of the shading can be analyzed. Further, aspects of the present disclosure can compute an amount of the rate of change for a group of primitives, and compare these rates. Aspects of the present disclosure can then re-shade primitives based on this computation.

Some aspects of the present disclosure can utilize object space shading, which can decouple the primitive shading and display. Temporal coherence can also be exploited to decouple visibility and shading. In some aspects, the present disclosure can determine which primitive is visible, e.g., in order to determine which primitive to shade. In some instances, a higher visibility rate can be used when object or camera movement is fast. Further, when the camera movement is fast, the present disclosure can determine the visibility rate based on the camera movement. Also, a higher shading rate can be used when there is fast movement or light change.

In some instances, the temporal coherence of view independent shading can be high. For instance, by decoupling view dependent or independent shading, the present disclosure can shade view independent parts at a much lower temporal rate compared to view dependent parts. This can be accomplished by splitting shaders into view dependent and view independent parts. Accordingly, the present disclosure can shade based on the view dependent and view independent parts. For example, aspects of the present disclosure can use two shaders for view dependent and view independent parts, which can result in a more efficient shading. Indeed, the view independent parts may be executed at a lower frequency.

In some aspects, certain images or frames can be the combined result of shading different aspects of an image or frame. For example, in some instances, a view independent portion of an image can compute shading at a relatively slow frequency, e.g., two times per second. In other aspects, a view dependent portion of an image can compute shading at a faster frequency, e.g., twenty times per second. A resulting image can combine the view independent portion of an image and the view dependent portion of an image. For instance, aspects of the present disclosure can include images that are a combination of view independent portions of the image and view dependent portions of the image.

Additionally, the present disclosure can calculate the individual rate of change based on each primitive or group of primitives. As mentioned herein, in some aspects, primitives can be clustered together in primitive groups or patches. As such, aspects of the present disclosure may not shade every primitive in every frame, as well as choose to update the shading based on the view dependency or view independency.

In some aspects, when visible geometry leaves a certain viewpoint, the corresponding shading information can be cached, e.g., as long as memory is not a constraint. When previously visible geometry then re-enters the view, the old shading information can be directly retrieved from the cache. As such, the present disclosure can retain old shading information, e.g., in a cache. Then if the camera moves back to a previous frame, the present disclosure can reuse that shading information. This can save execution costs, as long as there is enough memory to store the cache of old shading information. Accordingly, the reuse of shading information can extend to previously viewed frames.

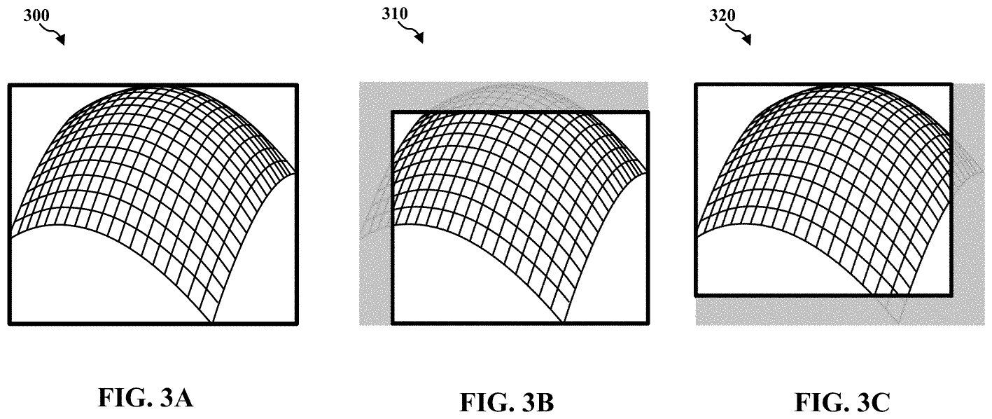

FIGS. 3A, 3B, and 3C illustrate images 300, 310, and 320, respectively, according to the present disclosure. Images 300, 310, and 320 illustrate different viewpoints or frames that can reuse shading information. For instance, the present disclosure can calculate shading information in image 300. Then the successive frames in images 310 and 320 can reuse this shading information. FIGS. 3A-3C compare the visible and invisible portions of a scene. For example, the entire scene in FIG. 3A is not shown in FIGS. 3B and 3C. Accordingly, the information in FIG. 3A is not fully utilized in FIGS. 3B and 3C. For instance, FIG. 3B includes a visibility inset in the bottom right portion of the image. FIG. 3C includes a visibility inset in the top left portion of the image. FIGS. 3A-3C display that aspects of the present disclosure can maintain the information in a certain image, e.g., FIG. 3A, and then use the information multiple times, such as through the use of a visibility inset. By reusing shading information, e.g., by using a visibility inset, the present disclosure can save both time and money during the shading process.

In some aspects, the resolution of a shaded primitive can change. In these cases, the shading may have to be recalculated. In some examples, this can happen if a frame or scene moves closer to or farther away from an object. Alternatively, the prior shading results can be resampled. This can also be the case if the resolution decreases. Therefore, the present disclosure can decide on whether to re-shade a primitive based on a change in viewpoint or resolution.

Some aspects of the present disclosure can allow for adaptive or change-based shading. In adaptive shading, aspects of the present disclosure can include a number of visible patches or primitives, Tᵢ, each associated with a pixel block, Aᵢ, in an atlas. Aspects of the present disclosure can include an absolute value of pixel block, e.g., |Aᵢ|, to represent the size of the block or the number of pixels in the block. In some aspects, the summed area of the patches or primitives can exceed the per-frame shading capacity, C. This can be expressed in a capacity formula that relates update frequencies fᵢ to C:

$${\sum }_{i} \vert {A}_{i} \vert \cdot {f}_{i} = C$$

Additionally, aspects of the present disclosure can assign to each patch a priority pᵢ that can be proportional to its rate of shading change. The shading frequencies, fᵢ, can also be proportional to the priorities, pᵢ. As such, the capacity formula can also be expressed as:

$${\sum }_{i} \vert {A}_{i} \vert \frac{{p}_{i}}{{p}_{j}} {f}_{j} = {f}_{i} {\sum }_{i} \vert {A}_{i} \vert \frac{{p}_{i}}{{p}_{j}} = C$$

Accordingly, shading frequency, fⱼ, can be expressed as:

$${f}_{j} = \frac{C}{{\sum }_{i} \vert {A}_{i} \vert \frac{{p}_{i}}{{p}_{j}}}$$

With the updated shading frequency, fᵢ, aspects of the present disclosure can compute a new deadline, Ωᵢ, for when Tᵢ should be shaded again. In some aspects, this may be no earlier than the next frame, e.g., frame t+1. Further, the last time Tᵢ was shaded can be αᵢ. This new deadline, Ωᵢ, can be expressed as:

$${Ω}_{i} = max ( {α}_{i} + \frac{1}{{f}_{i}} , t + 1 )$$

In some aspects, in frame t, the present disclosure can shade all patches Tᵢ with └Ωᵢ┘=t, as well as re-compute their pᵢ and reset αᵢ←Ωᵢ. Further, for all patches, including those that are not shaded in this frame, aspects of the present disclosure can re-compute fᵢ and Ωᵢ.

In some aspects, e.g., due to rounding errors, the estimated shading capacity in a frame C may be slightly overspent or underspent, which can lead to fluctuations of the shading frame rate. However, since aspects of the present disclosure use a decoupled rendering system, the display frame rate can be steady even if the shading frame rate is slightly fluctuating. In some instances, shading can go on continuously, but the choice of C can imply when the end of a shading frame is reached, such that aspects of the present disclosure may re-solve for fᵢ. In further aspects, C can be selected adaptively, such that the shading stage can finish before the final display stage starts a new frame. This can allow the most recent results to be picked up by the display stage. In some aspects, a feedback loop with hysteresis may be sufficient for this purpose.

For computing the shading change, aspects of the present disclosure can denote using h(x,t), the texel value at location x ϵ Aᵢ. The current frame can be denoted by t, and the frame when the patch was last shaded by αᵢ. In some aspects, the shading change can be proportional to pixel changes weighted by a metric p, normalized by area and by the shading rate, which can be expressed by:

$${p}_{i} ( t ) = \frac{1}{\vert {A}_{i} \vert} \frac{1}{t - {α}_{i}} {\sum }_{x ∈ {A}_{i}} ρ ( h ( x , t ) , h ( x , {α}_{i} ) )$$

Further, an example metric, ρ, may be the sum of absolute differences of an old pixel and a new pixel:

ρ(p, q)=|p−q|

Accordingly, the priority shading change rate can be expressed as:

$${p}_{i} ( t ) = \frac{1}{\vert {A}_{i} \vert} \frac{1}{t - {α}_{i}} {\sum }_{x ∈ {A}_{i}} {p}_{i} ( t )$$

As indicated above, the priority at time t can be dependent upon the change of all the pixels. As such, aspects of the present disclosure can compare two consecutive frames and sum the differences between the old and new pixels, wherein p is an old pixel and q is a new pixel. Accordingly, aspects of the present disclosure can determine the average shading change rate over both space and time.

In further aspects, the present disclosure can produce further savings in shading cost by spatial subsampling, e.g., allocating smaller patches, or by temporal subsampling, e.g., shading patches at a lower frame rate. However, aspects of the present disclosure may also utilize different ways to amortize the shading of patches with a long deadline, e.g., over several frames, while making partial results immediately usable for generating output frames.

Therefore, aspects of the present disclosure may shade a patch or primitive at a fractional frame rate. For instance, a patch Tᵢ may be shaded at a fractional frame rate of fᵢ·2^{Q}/q, Q ϵ N₀, q ϵ N. Further, the present disclosure can subdivide the domain of Aᵢ into a grid with cells of size M×M, e.g., 2×2 or 4×4 pixels. Also, inside of each cell, M²/2^{Q} pixels can be shaded per frame in a round-robin manner. As aspects of the present disclosure may operate in object space, this approach may require only bilinear upsampling and/or no re-projection bookkeeping. Further, aspects of the present disclosure can compute subsampled shading in a low-resolution buffer l(x,t) and fuse it into the full-resolution patch h(x,t) in the atlas. Also, the buffer, l, can cover the same domain as h, but at 1/M² of the pixel density.

In some aspects, e.g., for a sample at position x=[xᵤ, xᵥ]^{T}, aspects of the present disclosure can utilize bilinear upsampling l(x,t) of the four closest samples in l, e.g., forming a square around x, at positions denoted by x₀₀, x₀₁, x₁₀, and x₁₁. This can be denoted by the formula:

$$Δ x = \frac{x - {x}_{00}}{{x}_{11} - {x}_{00}}$$

Further, l(x,t)=l(x₀₀,t)(1−Δxᵤ)(1−Δxᵥ)+l(x₀₁,t)Δxᵤ(1−Δxᵥ)+l(x₁₀,t)(1−Δxᵤ)Δxᵥ+l(x₁₁,t)ΔxᵤΔxᵥ. In some aspects, the present disclosure can merge the new information into h with an exponential decay factor 0<λₑ<1:

h(x,t)←(1−λₑ)·h(x,t)+λₑ·l(x,t)

In some aspects, in order to integrate upsampling into the scheduling, aspects of the present disclosure may modify the deadline Ωᵢ to accommodate shading at a base rate of fᵢ/2^{Q}. This can be expressed by:

$${O}_{i} ( q ) = ⌊ {α}_{i} + \frac{q}{{2}^{Q} \cdot {f}_{i}} ⌋$$

$${q}_{min} = arg {min}_{q} ( {O}_{i} ( q ) ) , s . t . {O}_{i} ( q ) \geq t + 1$$

$${Ω}_{i} = {O}_{i} ( {q}_{min} )$$

In some aspects, after patch Tᵢ has been partially shaded and upsampled, it can be treated in the same way as a patch that was shaded fully, i.e., pᵢ can be recomputed and αᵢ can be reset. Moreover, aspects of the present disclosure can advance the round-robin counter c←(c+1)mod 2^{qmin}, e.g., to obtain the next round-robin position in the grid cell. In some aspects, if 2^{qmin}<M², then more than one pixel can be shaded per frame. In these cases, pixels shaded together in the cell can be offset by a vector of [2^{qmin}÷M, 2^{qmin} mod M]^{T} pixels in the cell.

As mentioned above, aspects of the present disclosure can include shading at fractional frequencies, which may be based on adaptive shading frequencies. For instance, aspects of the present disclosure may shade only a subset of pixels in a primitive per frame. For example, in four frames, aspects of the present disclosure may shade one pixel out of a 2×2 pixel rectangle per frame. Further, the newly shaded pixel can be merged with the old pixels using a strategy similar to temporal anti-aliasing. In some aspects, the present disclosure can utilize bilinear upsampling of the subsampled shading. In other aspects, the present disclosure can utilize a combination of the upsampled shading with the existing atlas using exponential decay. In some aspects, deadlines for fractional shading frequencies may be utilized, but aspects of the present disclosure may decide to schedule at the accuracy of 1/N frame, e.g., ¼ frame.

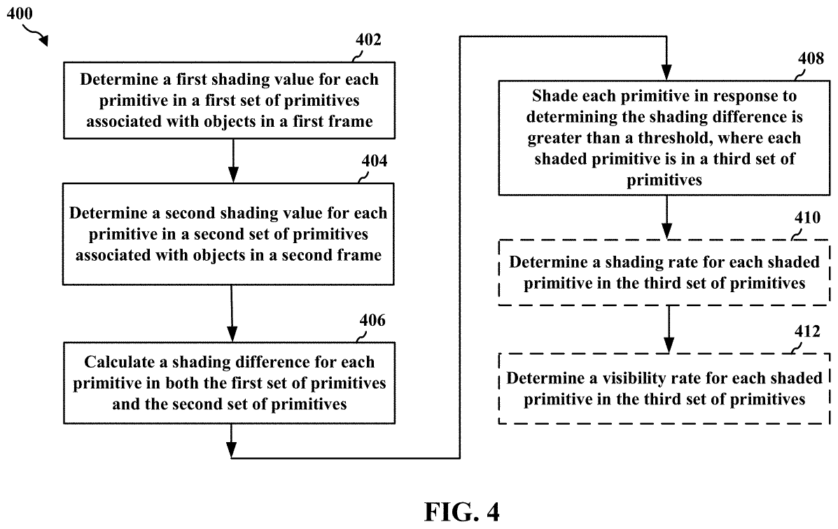

FIG. 4 illustrates an example flowchart 400 of an example method in accordance with one or more techniques of this disclosure. The method may be performed by a GPU or apparatus for graphics processing. At 402, the apparatus may determine a first shading value for each primitive in a first set of primitives associated with objects in a first frame, as described in connection with the examples in FIGS. 2A, 2B, 3A, 3B, and 3C. At 404, the apparatus can determine a second shading value for each primitive in a second set of primitives associated with objects in a second frame, as described in connection with the examples in FIGS. 2A, 2B, 3A, 3B, and 3C.

At 406, the apparatus can calculate a shading difference for each primitive in both the first set of primitives and the second set of primitives, as described in connection with the examples in FIGS. 2A, 2B, 3A, 3B, and 3C. In some aspects, the shading difference can be the difference between the first shading value and the second shading value for the primitive, as described in connection with the examples in FIGS. 2A, 2B, 3A, 3B, and 3C. At 408, the apparatus may shade each primitive in response to determining the shading difference is greater than a threshold, where each shaded primitive is in a third set of primitives, as described in connection with the examples in FIGS. 2A, 2B, 3A, 3B, and 3C.

At 410, the apparatus can also determine a shading rate for each shaded primitive in the third set of primitives, as described in connection with the examples in FIGS. 2A, 2B, 3A, 3B, and 3C. In some aspects, the determined shading rate for each shaded primitive in the third set of primitives may be based on a shading change metric. Additionally, the shading change metric can be an adaptive shading frequency, where the adaptive shading frequency can be based on at least one of a shading capacity of the first frame, a shading capacity of the second frame, a number of visible primitives in the first set of primitives, a number of visible primitives in the second set of primitives, or a plurality of pixels in each primitive in both the first set of primitives and the second set of primitives, as described in connection with the examples in FIGS. 2A, 2B, 3A, 3B, and 3C. Moreover, the adaptive shading frequency can be based on a subset of the plurality of pixels in each primitive in both the first set of primitives and the second set of primitives, as described in connection with the examples in FIGS. 2A, 2B, 3A, 3B, and 3C.

Also, the determined shading rate for each shaded primitive in the third set of primitives can be based on a shading change metric, as described in connection with the examples in FIGS. 2A, 2B, 3A, 3B, and 3C. Moreover, the determined shading rate for each shaded primitive in the third set of primitives may be based on a rate of motion of the primitive relative to a light source, as described in connection with the examples in FIGS. 2A, 2B, 3A, 3B, and 3C.

At 412, the apparatus can determine a visibility rate for each shaded primitive in the third set of primitives, as described in connection with the examples in FIGS. 2A, 2B, 3A, 3B, and 3C. In some aspects, each shaded primitive in the third set of primitives can be view dependent or view independent, as described in connection with the examples in FIGS. 2A, 2B, 3A, 3B, and 3C. Additionally, each view dependent primitive can be shaded at a higher frequency than each view independent primitive, as described in connection with the examples in FIGS. 2A, 2B, 3A, 3B, and 3C. In some instances, the first shading value for each primitive in the first set of primitives or the second shading value for each primitive in the second set of primitives can be stored in a shading cache, as described in connection with the examples in FIGS. 2A, 2B, 3A, 3B, and 3C.

In one configuration, a method or apparatus for operation of a GPU is provided. The apparatus may be a GPU or some other processor in graphics processing. In one aspect, the apparatus may be the processing unit 120 within the device 104 or may be some other hardware within device 104 or another device. The apparatus may include means for determining a first shading value for each primitive in a first set of primitives associated with objects in a first frame. The apparatus can also include means for determining a second shading value for each primitive in a second set of primitives associated with objects in a second frame. Further, the apparatus can include means for calculating a shading difference for each primitive in both the first set of primitives and the second set of primitives, where the shading difference is the difference between the first shading value and the second shading value for the primitive. The apparatus can also include means for shading each primitive in response to determining the shading difference is greater than a threshold, where each shaded primitive is in a third set of primitives. The apparatus can also include means for determining a shading rate for each shaded primitive in the third set of primitives. Additionally, the apparatus can include means for determining a visibility rate for each shaded primitive in the third set of primitives.

The subject matter described herein can be implemented to realize one or more benefits or advantages. For instance, the described graphics processing techniques can be used by GPUs or other graphics processors to reduce the amount of time necessary to render a frame. Further, the described graphics processing techniques can be used by GPUs to save on the costs of frame rendering. Indeed, the present disclosure can save time, effort, and costs by utilizing the aforementioned graphs processing calculations.

In accordance with this disclosure, the term “or” may be interpreted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices,. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method of operation of a graphics processing unit (GPU), comprising:
determining a first shading value for each primitive in a first set of primitives associated with objects in a first frame;
determining a second shading value for each primitive in a second set of primitives associated with objects in a second frame;
calculating a shading difference for each primitive in both the first set of primitives and the second set of primitives, wherein the shading difference is the difference between the first shading value and the second shading value for the primitive; and
shading each primitive in response to determining the shading difference is greater than a threshold, wherein each shaded primitive is in a third set of primitives.

2. The method of claim 1, further comprising determining a shading rate for each shaded primitive in the third set of primitives.

3. The method of claim 2, wherein the determined shading rate for each shaded primitive in the third set of primitives is based on a shading change metric.

4. The method of claim 3, wherein the shading change metric is an adaptive shading frequency, wherein the adaptive shading frequency is based on at least one of a shading capacity of the first frame, a shading capacity of the second frame, a number of visible primitives in the first set of primitives, a number of visible primitives in the second set of primitives, or a plurality of pixels in each primitive in both the first set of primitives and the second set of primitives.

5. The method of claim 4, wherein the adaptive shading frequency is based on a subset of the plurality of pixels in each primitive in both the first set of primitives and the second set of primitives.

6. The method of claim 2, wherein the determined shading rate for each shaded primitive in the third set of primitives is based on a rate of motion of the primitive relative to a light source.

7. The method of claim 1, further comprising determining a visibility rate for each shaded primitive in the third set of primitives.

8. The method of claim 1, wherein each shaded primitive in the third set of primitives is view dependent or view independent, wherein each view dependent primitive is shaded at a higher frequency than each view independent primitive.

9. The method of claim 1, wherein the first shading value for each primitive in the first set of primitives or the second shading value for each primitive in the second set of primitives is stored in a shading cache.

10. An apparatus for operation of a graphics processing unit (GPU), comprising:
a memory; and
at least one processor coupled to the memory and configured to:
determine a first shading value for each primitive in a first set of primitives associated with objects in a first frame;
determine a second shading value for each primitive in a second set of primitives associated with objects in a second frame;
calculate a shading difference for each primitive in both the first set of primitives and the second set of primitives, wherein the shading difference is the difference between the first shading value and the second shading value for the primitive; and
shade each primitive in response to determining the shading difference is greater than a threshold, wherein each shaded primitive is in a third set of primitives.

11. The apparatus of claim 10, wherein the at least one processor is further configured to:
determine a shading rate for each shaded primitive in the third set of primitives.

12. The apparatus of claim 11, wherein the determined shading rate for each shaded primitive in the third set of primitives is based on a shading change metric.

13. The apparatus of claim 12, wherein the shading change metric is an adaptive shading frequency, wherein the adaptive shading frequency is based on at least one of a shading capacity of the first frame, a shading capacity of the second frame, a number of visible primitives in the first set of primitives, a number of visible primitives in the second set of primitives, or a plurality of pixels in each primitive in both the first set of primitives and the second set of primitives.

14. The apparatus of claim 13, wherein the adaptive shading frequency is based on a subset of the plurality of pixels in each primitive in both the first set of primitives and the second set of primitives.

15. The apparatus of claim 11, wherein the determined shading rate for each shaded primitive in the third set of primitives is based on a rate of motion of the primitive relative to a light source.

16. The apparatus of claim 10, wherein the at least one processor is further configured to:
determine a visibility rate for each shaded primitive in the third set of primitives.

17. The apparatus of claim 10, wherein each shaded primitive in the third set of primitives is view dependent or view independent, wherein each view dependent primitive is shaded at a higher frequency than each view independent primitive.

18. The apparatus of claim 10, wherein the first shading value for each primitive in the first set of primitives or the second shading value for each primitive in the second set of primitives is stored in a shading cache.

19. An apparatus for operation of a graphics processing unit (GPU), comprising:
means for determining a first shading value for each primitive in a first set of primitives associated with objects in a first frame;
means for determining a second shading value for each primitive in a second set of primitives associated with objects in a second frame;
means for calculating a shading difference for each primitive in both the first set of primitives and the second set of primitives, wherein the shading difference is the difference between the first shading value and the second shading value for the primitive; and
means for shading each primitive in response to determining the shading difference is greater than a threshold, wherein each shaded primitive is in a third set of primitives.

20. The apparatus of claim 19, further comprising means for determining a shading rate for each shaded primitive in the third set of primitives.

21. The apparatus of claim 20, wherein the determined shading rate for each shaded primitive in the third set of primitives is based on a shading change metric.

22. The apparatus of claim 21, wherein the shading change metric is an adaptive shading frequency, wherein the adaptive shading frequency is based on at least one of a shading capacity of the first frame, a shading capacity of the second frame, a number of visible primitives in the first set of primitives, a number of visible primitives in the second set of primitives, or a plurality of pixels in each primitive in both the first set of primitives and the second set of primitives.

23. The apparatus of claim 22, wherein the adaptive shading frequency is based on a subset of the plurality of pixels in each primitive in both the first set of primitives and the second set of primitives.

24. The apparatus of claim 20, wherein the determined shading rate for each shaded primitive in the third set of primitives is based on a rate of motion of the primitive relative to a light source.

25. The apparatus of claim 19, further comprising means for determining a visibility rate for each shaded primitive in the third set of primitives.

26. The apparatus of claim 19, wherein each shaded primitive in the third set of primitives is view dependent or view independent, wherein each view dependent primitive is shaded at a higher frequency than each view independent primitive.

27. The apparatus of claim 19, wherein the first shading value for each primitive in the first set of primitives or the second shading value for each primitive in the second set of primitives is stored in a shading cache.

28. A computer-readable medium storing computer executable code for operation of a graphics processing unit (GPU), comprising code to:
determine a first shading value for each primitive in a first set of primitives associated with objects in a first frame;
determine a second shading value for each primitive in a second set of primitives associated with objects in a second frame;
calculate a shading difference for each primitive in both the first set of primitives and the second set of primitives, wherein the shading difference is the difference between the first shading value and the second shading value for the primitive; and
shade each primitive in response to determining the shading difference is greater than a threshold, wherein each shaded primitive is in a third set of primitives.

29. The computer-readable medium of claim 28, further comprising code to determine a shading rate for each shaded primitive in the third set of primitives.

30. The computer-readable medium of claim 29, wherein the determined shading rate for each shaded primitive in the third set of primitives is based on a shading change metric.
